(19) United States
(12) Patent Application Publication
(10) Pub. No.: US 2003/0202210 A1
(43) Pub. Date: Oct. 30, 2003

(54) Printing system and method for combining print job data with background image data

(76) Inventor: James E. Anderson, Meridian, ID (US)

Correspondence Address: HEWLETT-PACKARD COMPANY, Intellectual Property Administration, P.O. Box 272400, Fort Collins, CO, 80527-2400, US

(21) Appl. No.: 10/132,768

(22) Filed: Apr. 24, 2002

(51) Int. Cl. G06F 15/02; H04N 1/387

(52) U.S. Cl. 358/1.18; 358/1.6; 358/450

(57) ABSTRACT

A printing system for transferring print job data onto media preferably includes a printer having a print engine, a memory location for storing background image data defining specified media types, a selection device for choosing among the background image data and a controller configured to combine the print job data with the selected background image data for printing the print job data and the selected background image data on the media.

### FIELD OF THE INVENTION

This invention relates to document production. More particularly, the present invention provides a method and apparatus for combining print job data with background image data.

### BACKGROUND OF THE INVENTION

More and more often, computers are used to design documents of all kinds. The use of a computer has enabled even the layperson to create and print documents right from her own desktop. Document production software allows users to easily organize, edit, and apply text, graphics, logos, or other images in any configuration imaginable.

Most computers are configured to connect to printers and printing systems that allow users to complete the document production process. Printers and printing systems currently use many different types, sizes and quality of media, each one typically requiring a separate media tray. Some printers have multiple trays enabling specific types of media to be selected by a user with a control panel on the printer or a graphical user interface on the host computer. However, the introduction of multiple trays in a single printer requires the production of oversized printers, many of which have an enlarged footprint as compared to printers with a single print media tray.

Some printers with multiple media trays align the trays vertically under the printer to avoid an enlarged printer footprint, increasing the overall height of the printer. However, the increased height reduces the stability of the printer, and therefore the number of media trays is usually limited to two or three. In addition, there are sometimes other vertical constraints including a limited cabinet size or other issues that make numerous media trays an unattractive or unacceptable solution to printing on multiple pre-printed forms.

Many businesses and individuals, however, have significantly more than two or three media types that are used regularly. Therefore, most printers have a separate media feed slot into which special media types can be manually inserted. Such special media types include, for example, forms, letterhead, transparencies, envelopes, or other media. The special media types may also be placed on top of an existing stack of media in a media tray, and then removed when the special media is no longer needed. It can become quite inconvenient and time consuming, however, to manually feed or change the media in an existing tray every time a new media type is desired. Often the special media type is a pre-printed form that is quite expensive, but considered necessary by many because of the exceptionally clean and professional look pre-printed forms provide.

In addition, it is not uncommon for the printer to be connected to the user through a network and located a considerable distance from the user. This obviously adds to the time and inconvenience of printing if the user is required to provide and/or change the media in an existing tray each time a new or specialized document is produced.

Further, each printer tray typically requires separate pick, feed and guide rollers that contribute to the size, complexity, and expense of the printer. There have been recent efforts to share some of the media hardware between multiple media trays, for example U.S. Pat. No. 6,179,499 entitled “Auxiliary Print Media Tray for Printer” that enables two media supplies to share the same media feed mechanism, but such specialized mechanisms are expensive and not the norm.

While there have also been attempts to create electronic forms with specified formats, headings and other pre-printed displays and layouts to reduce the number of pre-printed media required, computer operators must use special software programs or embed escape sequences in order to make the electronically stored forms accessible when printing. Thus, the use of electronic forms has become a somewhat difficult and cumbersome way to avoid putting a set of preprinted forms in its own dedicated media tray.

### SUMMARY OF THE INVENTION

The present invention provides, among other things, a printing system for transferring print job data onto media including a printer having a print engine; a memory location for storing background image data defining specified media types; a selection device for choosing among said background image data; and a controller configured to combine print job data with selected background image data for printing print job data and selected background image data.

### BRIEF DESCRIPTION OF THE DRAWINGS

The foregoing and other features and aspects of the invention will become further apparent upon reading the following detailed description and upon reference to the drawings in which:

FIG. 1 is a perspective view of a printer according to one aspect of the present invention.

FIG. 2 is a schematic view of a media path of the printer of FIG. 1.

FIG. 3 shows a graphical user interface panel according to one aspect of the present invention.

FIG. 4 shows a data structure according to one aspect of the present invention.

FIG. 5 shows a data structure according to one embodiment of the present invention.

FIG. 6A shows a graphical user interface panel according to one aspect of the present invention.

FIG. 6B shows a graphical user interface panel according to another aspect of the present invention.

FIG. 7 is a block diagram of a computerized printing system according to one aspect of the present invention.

FIG. 8 is a flow chart according to one aspect of the present invention.

FIG. 9 is a schematic block diagram according to one embodiment of the present invention.

In the drawings, identical reference numbers indicate similar, but not necessarily identical, elements. While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed, but on the contrary, the intention is to cover all modifications, equivalents, and alternatives falling within the spirit and scope of the invention as defined by the appended claims.

### DETAILED DESCRIPTION OF ILLUSTRATED EMBODIMENTS

Illustrative embodiments of the invention are described below. As will be appreciated by those skilled in the art, the present invention can be implemented in a wide variety of printing devices including, but not limited to, laser printers, inkjet printers, facsimile machines, copiers, plotters, etc. As used herein, and in the appended claims, the term “printer” is defined to mean any device that outputs a hard-copy document on paper or some other print medium, including, but not limited to, those printing devices mentioned above.

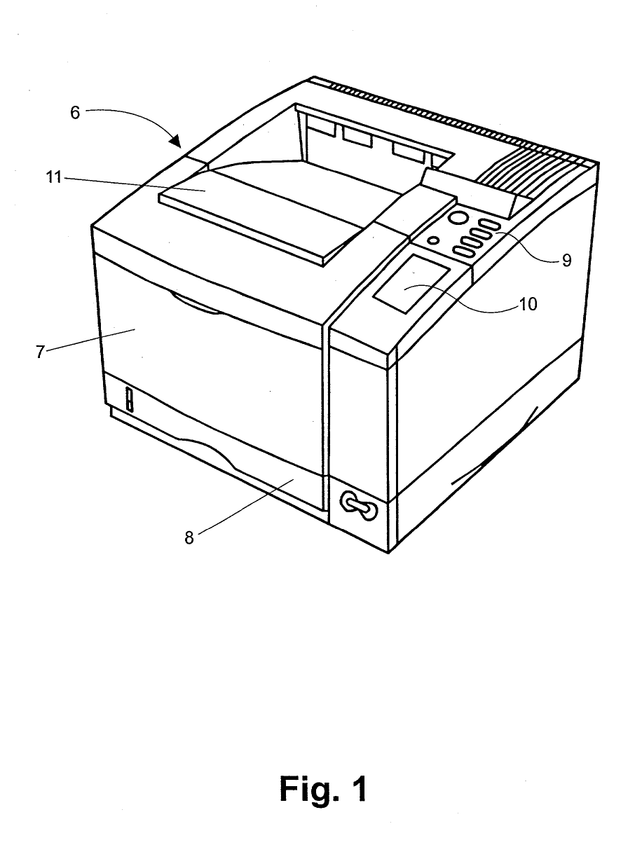

Turning now to the figures, and in particular to FIG. 1, a printer (6) that may be used according to one aspect of the present invention as a portion of a printing system is shown. Printer (6) is shown as a laser printer. However, as noted above, any printing device may be used as the “printer” in an embodiment of the present invention. Any printers using electrostatic, inkjet, LED, dye sublimation, dot matrix, or other printing technologies may also be used to create a printing system according to one aspect of the present invention.

Printer (6) may include one or more media trays, for example first media tray (7) and second media tray (8). It will be understood by those of skill in the art having the benefit of this disclosure, however, that other media trays may also be added to or replace trays (7) and (8) of printer (6) as desired. Additionally, a printer according to the present invention may not have any media trays, but may simply have a bay or supply area into which a supply of print media is placed.

Printer (6) may also include a control panel (9) and a display window (10) that allow a user to adjust printer settings, monitor printer status, and perform other general printer control functions.

Printer (6) also includes an output device such as output tray (11), which may hold printed materials after the printing process is done.

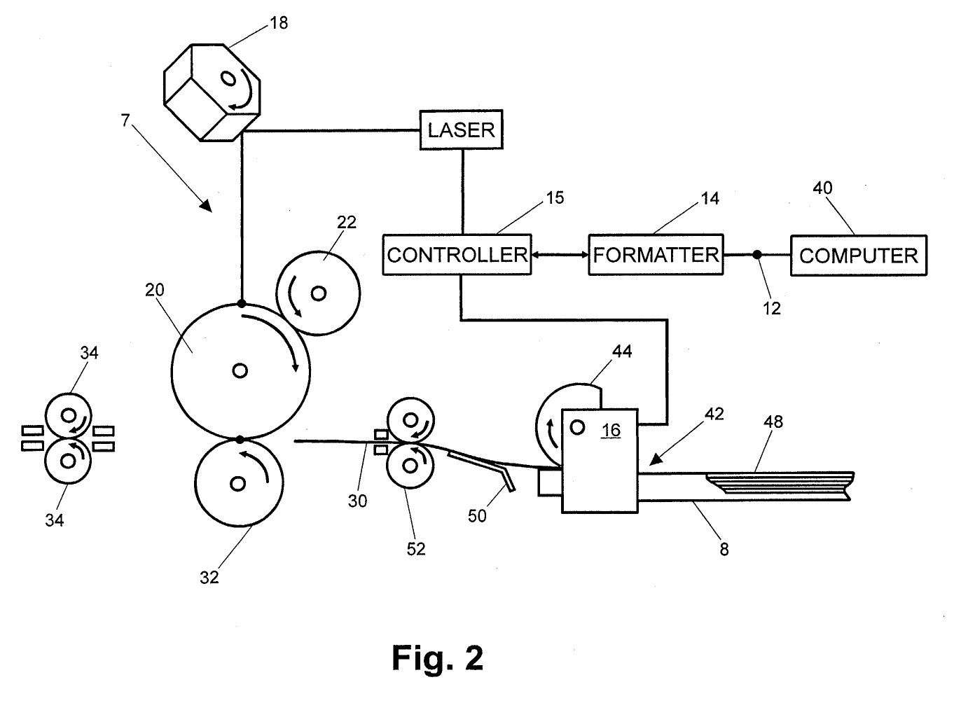

Operation of a printer such as laser printer (6) may be described as follows with reference to FIG. 2: According to the embodiment of FIG. 2, a computer (40) may provide printing data to an input port (12) of printer (6). Printing data transmitted by the computer is usually received by a formatter (14), which may include a microprocessor, programmable memory, and a page buffer (not shown).

The formatter (14) arranges the printing data transmitted by the computer (40) as an electronic representation of each page a user wishes to print with printer (6). The formatter (14) may then store the electronic representation of each page in the programmable memory until required by the page buffer portion of formatter (14). The page buffer portion of formatter (14) arranges the printing data comprising the electronic representation of each page into a series of line components that are sent sequentially to a printer controller (15).

Printer controller (15) manipulates a light beam produced by a laser (16) to form a latent image to be printed on a photoconductive drum (20). A mirror (18) may be used to reflect the light beam from laser (16) onto the photoconductive drum (20). Photoconductive drum (20) may be rotated such that each line component of the printing data is in turn electrostatically reproduced on the drum.

A developing roller (22) may transfer toner to photoconductive drum (20) according to the electrostatic pattern “written” on the drum by laser (16). The toner is typically charged opposite of the electrostatic pattern such that the toner is attracted to the electrostatic pattern on the drum (20). The toner pattern on photoconductive drum (20) is then transferred onto print medium (30) that is advanced through the printer by transfer roller (32) and output rollers (34).

Print media (30) may originate in a print media tray (48) of printer (6). The print media (30) is then advanced by transfer roller (32) with the aid of one or more feed rollers (44) and registration rollers (52).

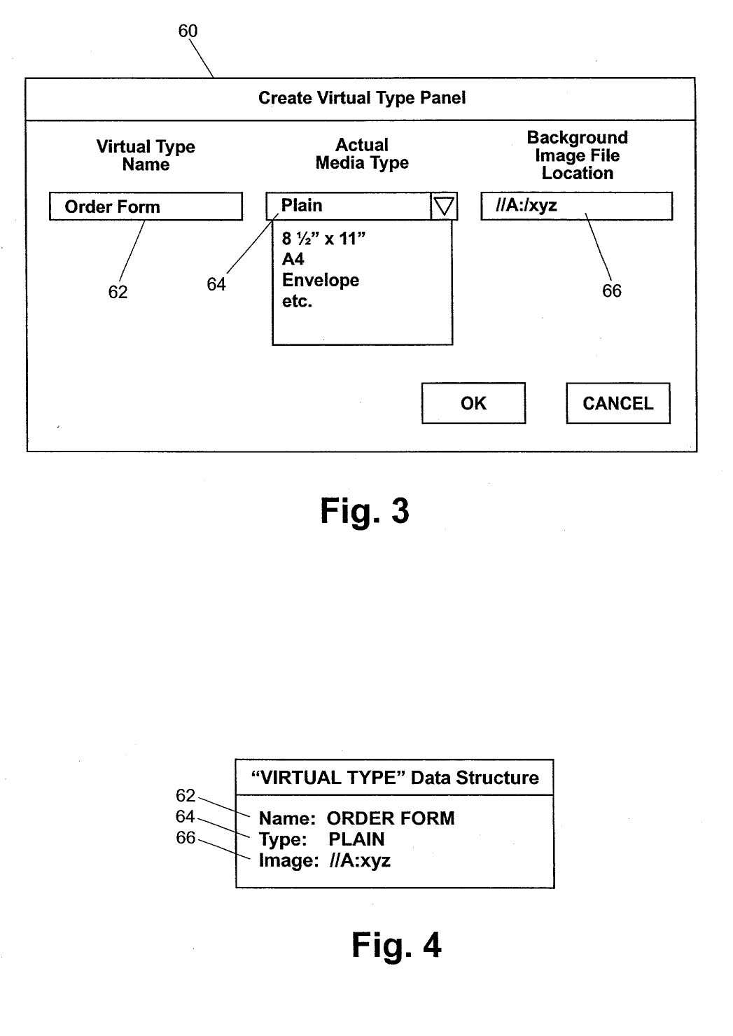

FIG. 3 illustrates an exemplary graphical user interface screen for operating a printing system according to the present invention. Interactive screen (60) may be displayed on, for example, computer (40). Computer (40) may be considered as a component of a printing system that includes a printer such as printer (6). Printer (6) may be replaced in some imaging systems embodiments, however, by a fax machine, a copier, or the like. Interactive screen (60) may also appear on a printer itself such as on display window (10) of printer (6).

Interactive screen (60) may be used to create and specify a virtual pre-printed media type to be combined and simultaneously printed with a print job according to the description above (or with other printing technologies) to create documents with the appearance of a pre-printed media type but with the low cost and convenience of being printed from a printer such as printer (6).

A specified media type may include, but is not limited to: letterhead, forms, documents, questionnaires, and the like. The specified media types of the present invention are not actual pre-printed pages, but instead include an electronic background image which may be stored in a memory location including, but not limited to, the memory of computer (40), the memory found in a printer such as printer (6), a network memory location, or an internet memory location.

Therefore, the background image advantageously defines a virtual pre-printed media type that may be combined with a print job and printed by printer (6) or another printing device operatively connected to computer (40). The background image may include, but is not limited to: text, graphics, pictures, symbols, logos, characters, and numbers arranged in any configuration on a print media such as paper.

A user may thus engage interactive screen (60) to create and identify a virtual pre-printed media type for selection by a user. Interactive screen (60) may be created and implemented by, for example a software system or firmware system running on computer (40), a network location, a web location, or on printer (6).

According to the embodiment of FIG. 3, a user may create a virtual pre-printed media type by labeling a desired virtual pre-printed media type with a name in box (62), and associating the name in box (62) with an actual paper type in box (64) and a background image file location in box (66). As shown, box (64) may include a pull-down menu allowing a user to select from available sizes and types of actual print media. It will be understood, however, that the interface illustrates in FIG. 3 is merely one possible embodiment and that any other interface design that allows a user to associate a background data set with an actual media type may be used in an embodiment of the present invention.

The actual media type may include any media actually found in the trays or media supply areas of printer (6). Such actual media types may include, but are not limited to, plain paper of any size (e.g. letter, legal, A4, etc.), envelopes, transparencies, cardstock, and the like. The actual media types will advantageously not be pre-printed, reducing the expense of the media and the number of individual trays needed for each pre-printed media type.

According to one embodiment of the present invention, the background image for integration with a print job may be stored in a file location and combined with the print job to create the appearance of pre-printed media. The use of the term “virtual pre-printed media type” thus indicates that instead of having an actual pre-printed form in a printer tray, a stored background image may be retrieved and printed on whatever media type is available in a printer tray—along with print job data—to create the appearance of pre-printed media.

The background image for a virtual pre-printed media type may be identified, for example, by designating a file name in box (66) of FIG. 3.

The specification of the virtual pre-printed paper type created by a user according to the input into screen (60) may, in some embodiments, be recorded as a separate data structure such as the one shown in FIG. 4. According to the embodiment of FIG. 4, the virtual pre-printed paper type specification may be recorded in a memory location on printer (6), computer (40), a network location, a web location, or other location according to structure shown in FIG. 4 with the name (62), paper type (64), and background image file location (66).

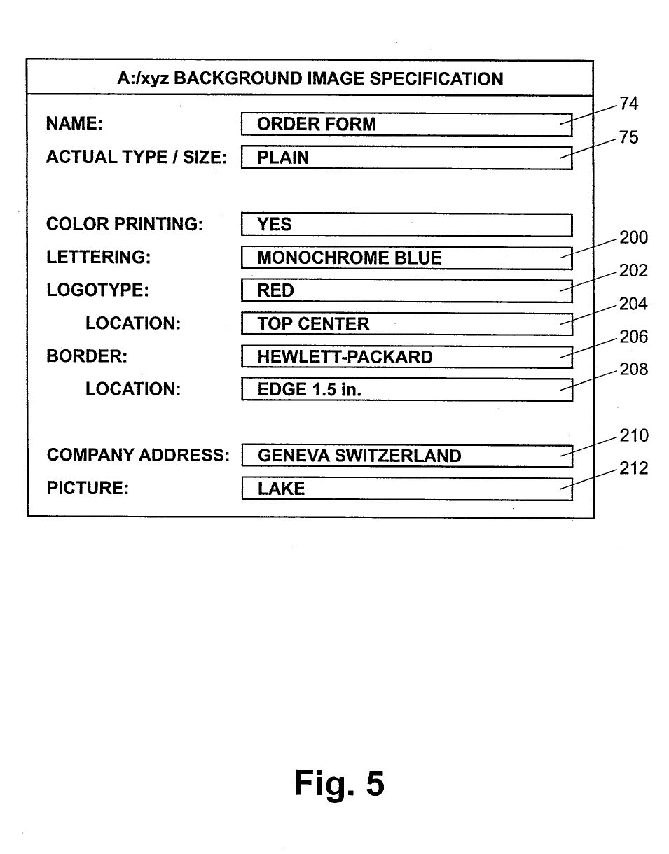

Referring next to FIG. 5, the background image file (the location of which may be entered at box (66) of FIG. 3) defines, at least in part, a specified media type. The parameters of a background image for printing with a print job may be specified according to any desired format. According to the embodiment of FIG. 5, the background image file located at, for example, A:/xyz may be specified by parameters including a virtual pre-printed media name (74) and an actual print media type (75) found in a tray of printer (6). The virtual pre-printed media name (74) and actual paper type (75) may be imported into the background image file parameters from the inputs of the user into boxes (62) and (64) (see FIG. 3).

If desired, a border may be specified for the background image at box (206) and the placement thereof at box (208). Other specification parameters of the background image may also be defined as desired by the user, such as the specification of a company address at box (210) and a picture at box (212) that a user wishes to associate with the printing of certain virtual pre-printed media types, which is, in the present example, “Order Form” (74). It will be understood that other specification data for a background image may also be specified as desired and that FIG. 5 is exemplary in nature.

Such other parameters that may be included in a background image may include, but are not limited to: logos, borders, text, graphics, pictures, and the like. Location on the media, fonts, colors and other characteristics may also be specified according to need and desire. In the embodiment of FIG. 5, the background image parameters include lettering color (200), logo type (202), logo type location (204), border (206), border location (208), company address (210), and picture (212). Software or firmware may be used to retrieve the various logos, borders, texts, graphics, pictures, and the like and combine them into the background image.

The location of the background image data may be in a memory module of printer (6), computer (40), a network drive, a web location, or other location accessible to a user.

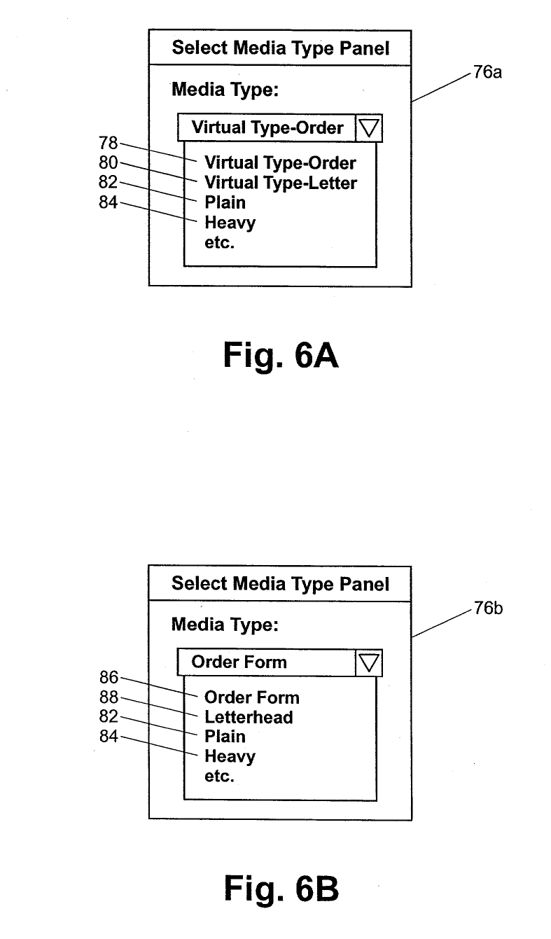

Turning next to FIGS. 6A and 6B, user interface menus (76A) and (76B) enabling a user to choose a virtual pre-printed media type is displayed. The interface menus (76A) and (76B) may be located in a software application, a driver, a printer control panel, or the like. For example, menus (76A) and (76B) may be displayed when a user opens a document production software tool such as a word processor. Alternatively, menus (76A) and (76B) may be displayed when a user selects a printing options menu of a document production software tool. Menus (76A) and (76B) are exemplary in nature and may include selections other than or in addition to the selections shown in FIGS. 6A and 6B

Referring to FIG. 6A, a user may select to print a print job on a specified media type, which may include virtual and/or actual media types. For example, a user may select to print a print job on a Virtual Type-Order (78), a Virtual Type-Letter (80), or on Plain paper (82). Other selections may also be available as created by the process described above or other similar processes. Menu (76A) may be integrated with any current media selection menus found on software programs, printer drivers and printers currently available for ease of use.

FIG. 6B shows an alternative menu format (76B), in which all media types (actual and virtual) are identified by name only. For example, a user may have the choice of printing on Order Form (86), Letterhead (88), or Plain (82). According to the menu format of (76B), a user may not know what media types are actual and which are virtual, and it is unnecessary for a user to distinguish the actual media types from the virtual media types, as the printed output of virtual media types will appear to be an actual pre-printed media type. While it appears from menu format (76B) that a printer such as printer (6) may actually have Order Forms, Letterhead, and Plain paper in separate trays, in fact, the printer may only have plain paper which will be printed according to the print job and background image data so as to appear like pre-printed media type.

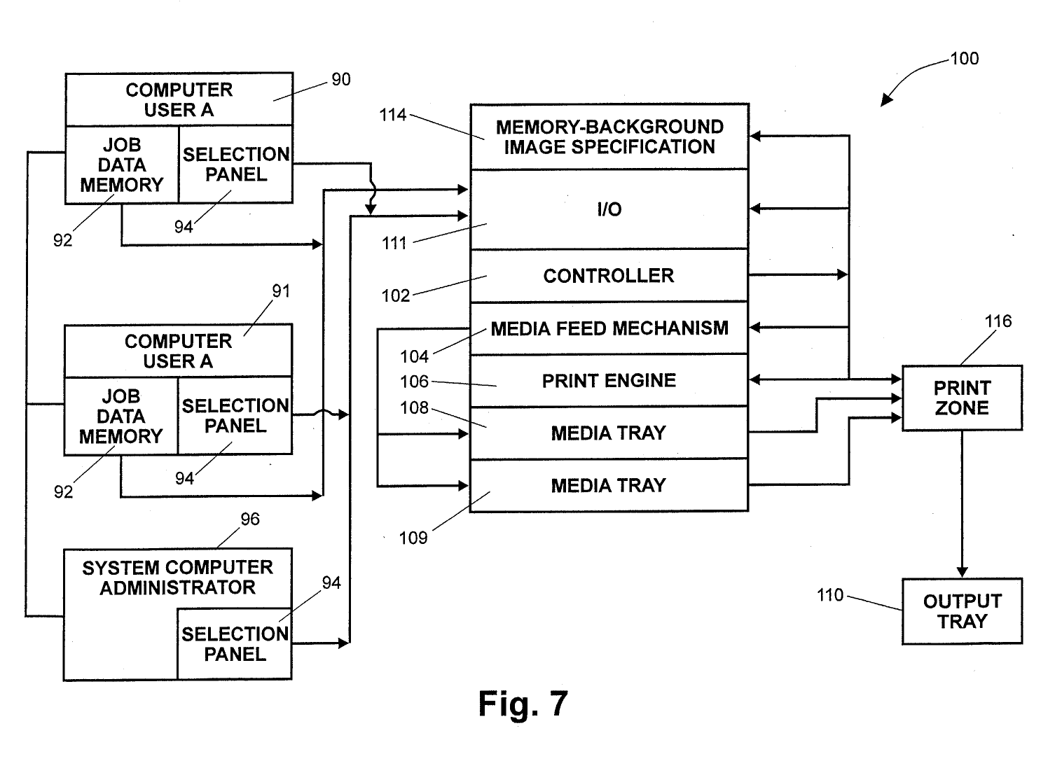

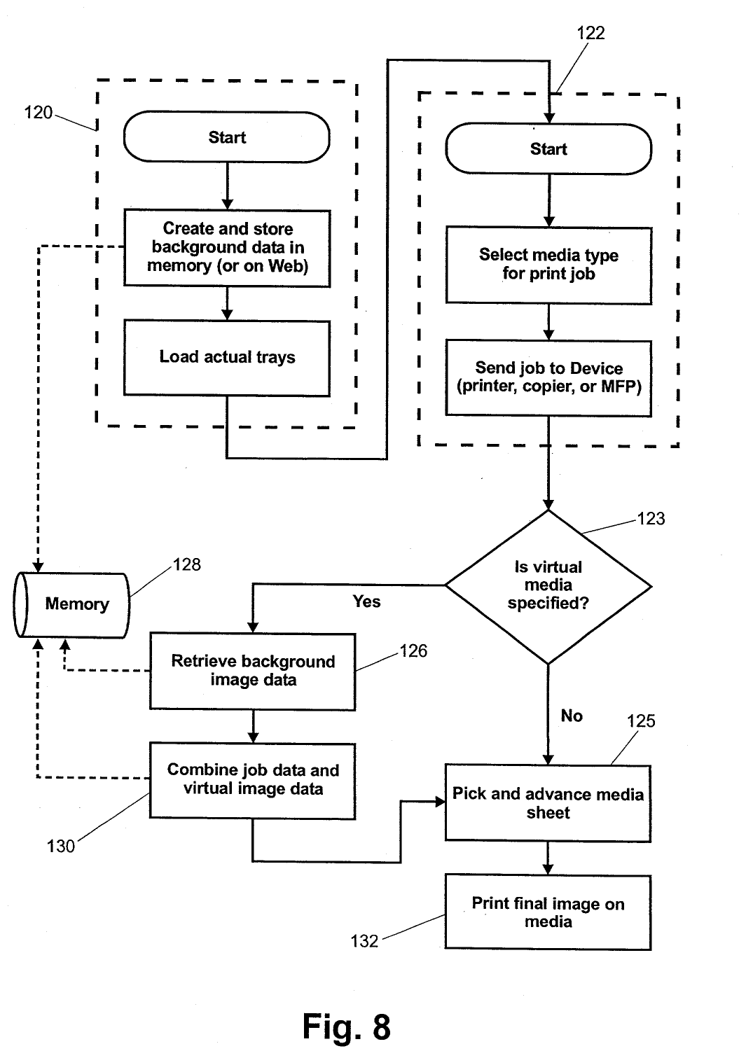

Operation of a printing system using virtual pre-printed media types may be described with reference to FIGS. 7 and 8. In the computer network embodiment of FIG. 7, the virtual media type is created for storage and access in the imaging device itself, for example, a network printer (100). The system as shown includes two network computers (90) and (91) each having a print job data memory (92) and a selection panel (94). A system administrator computer (96) also includes the selection panel (94). Network printer (100) includes a controller (102), media feed mechanism (104), print engine (106), media trays (108) and (109), and media output tray (110). An I/O connection (111) provides communication between the computers and network printer (100) such that controller (102) can selectively retrieve appropriate virtual media data as stored in memory location (114) so that both background “preprinted” images can be applied with job data as a composite onto actual media in a print zone (116). Thus the hardcopy printout produced in output tray (110) gives the visual impression of using many more media types than are actually located in the media supply trays.

Controller (102) may operate as gatekeeper device for pointing to and gathering the background image data and the associated actual media types specified by a user. Background image data may thus be stored at a location remote from controller (102) such as memory location (114), or the data may be stored in a memory location at the controller (102) itself.

Memory location (114) is accessible in the present embodiment to all network computers (90) and (91) in a shared location such that updating a virtual pre-printed media type such as letterhead, order forms, or other standardized forms can be done only once.

According to the embodiment shown as FIG. 7, a user at computer (90) may create a document that is intended to be printed, for example, on company letterhead. Before or after a user at computer (90) has completed the letter and is ready to print, the user may open selection panel (94) to choose the virtual pre-printed media type she wishes to print the letter on. The user may see a menu similar to the menu of FIG. 6B upon opening selection panel (94), which will give the user the option to print the letter on “Letterhead” (88). The user may select among the specified media types by manipulating a selection input device such as a mouse. Thus, the on-screen menu or user interface and the input devices that a user uses to control together constitute a selection device for selecting a media type (virtual or actual) on which to print.

When a user has selected, for example “Letterhead” (88) from the menu shown in FIG. 6B, computer (90) or controller (102) may combine the print job data with the background image data to print a single document as a virtual pre-printed letter. The text of the letter itself may be the print job data in the present example, but any other document may also comprise print job data. Print job data may be stored in a job data memory location (92). Controller (102) may include hardware or software or a combination of each that is programmed to gather print job data and background image data to create a single document appearing to be on a pre-printed media type with the simple selection of a virtual media type.

Controller (102) and/or computer (90) may also include programming to prioritize data received from the print job and the background image. The data prioritization may include suppressing a portion of the data received from the print job or the background image such that printing of any background image data at a location on the media also specified by the print job will not take place. That is to say that if both the print job and the background image contain instructions to print at coincident areas of a page, the portion of the background image coincident with the print job will be suppressed. The suppression of a portion of the background image will thus further add to the appearance of a pre-printed media type.

Alternatively, controller (102) and/or computer (90) may be programmed to prioritize data received from the print job and the background image such that a portion of the print job data is suppressed in the event of a specification area common to both the print job data and the background image data.

When controller (102) and/or computer (90) has combined and, if necessary, prioritized the print job data and background image data, it may send appropriate signals to print engine (106) to create the virtual pre-printed document. The print engine (106) may then operate to apply the image comprising the print job data and the background image data onto a sheet of media in media tray (108) or (109) and output the document to output tray (110).

Turning next to FIG. 8, there is shown a flow chart illustrating the steps for creating virtual pre-printed media documents according to one embodiment of the present invention. The flow chart includes the steps of creating and storing background image data defining the virtual pre-printed media type and loading printer trays with actual media at box (120). The creation of a background image may be accomplished according to the description above with reference to FIG. 5, however, the creation of a background image is not limited to the specifics discussed above. Any method of creating a background image may also be used. The background image may then be stored in a memory location (128) for retrieval by a computer or other printer controller.

The second portion of the flow chart shown in FIG. 8 illustrates the creation of a document on a virtual pre-printed media type. Referring to box (122), a user may select a specified media type (from, for example, a menu such as FIG. 6B) for a particular print job and send the print job to an imaging device. A determination is then made at box (123) to see if the specified media type selected is a virtual pre-printed media type. If the specified media type selected is not a virtual pre-printed media type (i.e., the selection did not include one of the background images created in box 120), then a media sheet is immediately picked and advanced as shown at box (125) and the final image is printed at box (132).

However, if the specified media type selected is a virtual pre-printed media type, the background image specifications are retrieved from memory (128) at box (126). The background image specifications are then combined with the print job at box (130) and the combined document is printed.

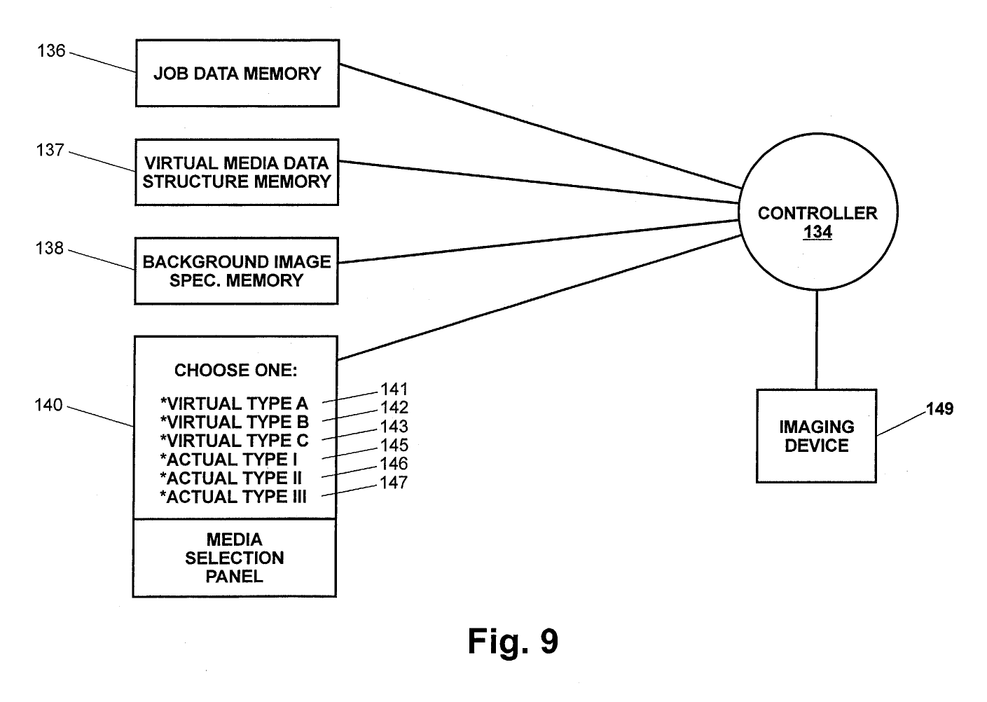

FIG. 9 is a high level block diagram showing the interactions between a controller (134) and various memory locations (136, 137, 138) which enable a selection panel (140) to be used for choosing among virtual media types (141, 142, 143) and actual media types (145, 146, 147) for printing out a particular job from an imaging device (149).

It will therefore be appreciated by those skilled in the art that the foregoing description in conjunction with the accompany drawings provides a printing system and method which creates a hybrid type of media type, namely, a virtual pre-printed media type which is a combination of a specific size and type of media actually located in a printer with an electronically stored standardized specification for layout, format and content. The printer can be a monochrome or color printer; and can employ various types of printer engines including laser, thermal inkjet, piezo inkjet, LED, thermal dye, dot matrix, and the like, or any other type of computerized printer.

The data structure and background image data for the virtual media type can be stored on any software or hardware storage medium including printer or computer hard disks, floppy disks, firmware, hardware, removable storage, internet storage, CD, DVD, RAM, etc. There may be a variable in the printer to allow a virtual media type to be defined by reference to an actual type of media (e.g. plain paper, Z-Fold multiple copy, transparency, glossy photo) in combination with the electronically stored virtual media specification. Based on a display panel on the printer or a remote control device (desktop, handheld, internet, etc.), a user may choose a media type in the same manner it is done conventionally. When printing occurs, the printer controller may actuate the appropriate media supply identified in the virtual media type specification to be fed along a media path to the print engine.

According to one embodiment, the firmware of the printer may assist to combine the electronically stored virtual media specification data with the print job data and print a page as if the electronically stored document is in a layer below the print job sent. If the electronically stored background image specification and the current print job specify that any portion of their combined printout are scheduled to be on the same location, the current print job may have priority, and the electronically stored background image data will not print on that location.

What is claimed is:

1. A printing system for transferring print job data onto media comprising:
a printer having a print engine;
a memory location for storing background image data defining specified media types;
a selection device for choosing among said background image data; and
a controller configured to combine said print job data with said selected background image data for printing said print job data and said selected background image data on said media.

2. The system of claim 1, wherein said specified media types each comprise an actual media type supplied to said printer associated with a background image from said background image data.

3. The system of claim 1, wherein said memory location is in said printer.

4. The system of claim 1, wherein said memory location is one or more of a computer, a removable storage device, a network drive, and an internet server.

5. The system of claim 1, wherein said selection device comprises a media selection menu on a computer screen.

6. The system of claim 1, wherein said selection device comprises a media selection menu on a control panel of said printer.

7. The system of claim 1, wherein said selection device comprises a media selection menu that comprises a choice of actual media types supplied to said printer and a choice of virtual media types comprising background image data stored in said memory location.

8. The system of claim 1, wherein said printer comprises a laser printer.

9. The system of claim 1, wherein said background image data comprises alphanumeric, graphical, or pictorial representations to be printed at specified media locations.

10. The imaging system of claim 9, wherein said controller further comprises a priority system for said specified media locations, said priority system preventing the printing of any of said background image data at a location also specified by said print job data.

11. The imaging system of claim 9, wherein said controller comprises a gatekeeper and includes instructions to gather said background image data from said memory location and send said background image data to be printed on an actual media type.

12. A method of creating virtual pre-printed media documents comprising:
storing a plurality of background images in a first memory location;
receiving print job data;
selecting a background image from said plurality of background images; and
combining said background image and said print job data into a single document.

13. The method of claim 12, further comprising printing said background image and said print job data as an integrated document.

14. The method of claim 12, further comprising prioritizing the combination of said background image and said print job data such that no specified media location includes printing of both said background image and said print job data.

15. The method of claim 14, further comprising suppressing the printing of any background image portion coincident with a specified media location common to said print job data.

16. The method of claim 14, further comprising suppressing the printing of any print job portion coincident with a specified media location common to said background image.

17. The method of claim 12, wherein said selecting a background image further comprises displaying a list of background image identifiers.

18. The method of claim 17, further comprising selecting a background image identifier using a user input device.

19. The method of claim 12, wherein the combining of said background image and said print job data comprises:
retrieving said selected background image from said first memory location;
feeding a sheet of print media associated with said selected background image; and
printing said print job data and said selected background image in combination on said sheet of print media.

20. A method of creating a document comprising:
combining print job data with a selected background image; and
printing said combined print job data and selected background image on a single sheet of print media.

21. The method of claim 20, further comprising:
displaying a list of background images; and
selecting one of said background images as said selected background image.

22. The method of claim 20, further comprising associating each of a plurality of background images with an actual print media type.

23. The method of claim 22, wherein said printing further comprises printing said combined print job data and selected background image on a sheet of print media of the type associated with said selected background image to give the appearance of pre-printed media.

24. The method of claim 23, wherein said print job data and said background image are printed simultaneously.

25. A printing system comprising:
means for combining print job data with a selected background image; and
means for printing said combined print job data and selected background image on a single sheet of print media.

26. The system of claim 25, further comprising:
means for displaying a list of background images; and
means for selecting one of said background images as said selected background image.

27. The system of claim 25, further comprising means for associating each of a plurality of background images with an actual print media type.

28. A method of computerized printing comprising providing a menu of printing parameters, said printing parameters including a choice of virtual pre-printed media types.

29. The method of claim 28, wherein said printing parameters further include a choice of actual print media type.

30. The method of claim 29, wherein said virtual pre-printed media type comprises a stored image configured to be combined with a print job on said actual print media type.

31. The method of claim 28, further comprising providing a user-activated selection device for selecting among the choices of virtual pre-printed media types.

32. The method of claim 28, further comprising providing a network of computers or printers having access to a shared file containing the specifications of said virtual pre-printed media types.

33. Computer readable instructions stored on a medium for storing computer readable instructions, said instructions, when executed, causing a computer or processor to provide a menu of printing parameters, said printing parameters including a choice of virtual pre-printed media types.

34. The computer readable instructions of claim 33, wherein said printing parameters further include a choice of actual print media type.

35. The computer readable instructions of claim 33, wherein said instructions cause said computer or processor to retrieve a stored image and combine said stored image with a print job on an actual print media type.

36. Computer readable instructions stored on a medium for storing computer readable instructions, said instructions, when executed, causing a computer or processor to display a list of background images; allow a user to select one of said background images; and combine said selected background image with a print job to create the appearance of printing on a pre-printed media type.

37. The computer readable instructions of claim 36, wherein said instructions cause said print job and said background image to be printed simultaneously.

38. The computer readable instructions of claim 36, wherein said instructions cause portions of said background to be suppressed if the placement of said portions of said background image coincide with the placement of said print job.
